(19) United States
(12) Patent Application Publication
(10) Pub. No.: US 2006/0202057 A1
(43) Pub. Date: Sep. 14, 2006

(54) Fertilizer Distribution Apparatus

(76) Inventors: Brian Carr Taggart, Phoenix, AZ (US); Ryan Dohse, Gilbert, AZ (US)

Correspondence Address: GOT PATENT? LLC, P.O. BOX 93891, PHOENIX, AZ, 85070-3891, US

(21) Appl. No.: 10/906,774

(22) Filed: Mar. 6, 2005

(51) Int. Cl. B05B 7/26

(52) U.S. Cl. 239/310

(57) ABSTRACT

A multi-purpose fertilizer distribution apparatus is described that can be incorporated into a new or existing underground irrigation system that facilitates the distribution of either liquid or solid fertilizer in the form of tablets or pellets. A main canister is adapted with an air sealed removable lid to allow access to replenish the fertilizer. The main canister has an integrated rod to hold specially designed fertilizer tablets and utilizes standard connectors to connect the apparatus to both the fluid source line of the irrigation system and the output line. The main canister permits connectors with integrated filters to be attached to permit easy connection between the apparatus and the irrigation system piping. The entire apparatus may be buried in the ground and is accessible at ground level for replenishment of fertilizer.

The present invention outlines a novel apparatus designed to fertilize a fluid in a fluid irrigation system. The apparatus is meant to be incorporated between the fluid source input of the irrigation system and downstream irrigation outlets used to distribute the fluid to the desired objects. The apparatus comprises of a canister with two apertures at the base of the canister to permit continuous fluid flow through the canister and allow for interaction of the continuous fluid flow with the fertilizing agent placed inside the canister apparatus. The apparatus is designed such that the apparatus permits easy access to the cavity in the canister through an air-tight sealed lid. The canister can come with an integrated rod rising from the center of the base of the canister. The center rod has the purpose of permitting placement of a fertilizer tablet with a hollowed center aperture to hold the fertilizing tablet near the base of the canister. The apparatus allows for the continuous fluid flow from input to output and flow past the fertilizer tablet to dissolve the fertilizing chemicals into the fluid flow of the irrigation system permitting steady fertilization of the fluid flow while a fertilizing chemicals exists in the canister. The irrigation fluid, having flowed through the canister and interacting with the fertilizer tablet to dissolve the fertilizing chemicals into the irrigation fluid, would then be distributed to the irrigation outlets comprising, but not limited to, sprinklers and drip system valves. When the irrigation system is not in use, turned off manually, or turned off by an automatic timer, the fluid flow through the canister chamber would cease, and the fertilizer tablet would remain in place for the next irrigation cycle.

After a number of irrigation cycles, the fertilizer chemicals or fertilizer tablet would ultimately be completely dissolved by the irrigation fluid. At such time, or even before original fertilizer chemicals or fertilizer tablet is completely dissolved, a new fertilizer tablet could be added to the fertilizer distribution apparatus to replenish the irrigation system and continue fertilization. One skilled in the art, can readily appreciate and understand the compatibility of the apparatus to utilize various fertilizing tablets or pellets depending on the season of the year, the object being fertilized, and the desired outcome of the fertilization, including, but not limited to, weed removal, pesticides, chemicals to remove hard water buildup removal in the fluid irrigation system, or chemicals designed for accelerated growth.

The fertilizer distribution apparatus can be readily incorporated into a new or existing fluid irrigation system utilizing standard connectors. The connection of the apparatus to the irrigation system is completed by utilizing industry standard connectors, including, but not limited to, compression fittings or threaded connectors to form a water-tight connection between the fluid flow source and the apertures of the fertilizer distribution apparatus.

The fertilizer distribution apparatus can be manufactured in a variety of ways including, but not limited to, injected molded plastic, metal, alloys, and PVC.

This thus outlines several key features and applications of the fertilizer distribution apparatus described herein but are not meant to be limiting in the application as viewed by those skilled in the art.

In order to understand the manner in which embodiments are obtained, a more particular description of various embodiments briefly described above will be rendered by reference to the appended drawings. These drawings depict embodiments that are not necessarily drawn to scale and are not to be considered to be limiting of its scope. Some embodiments will be described and explained with additional specificity and detail through the use of the accompanying drawings in which:

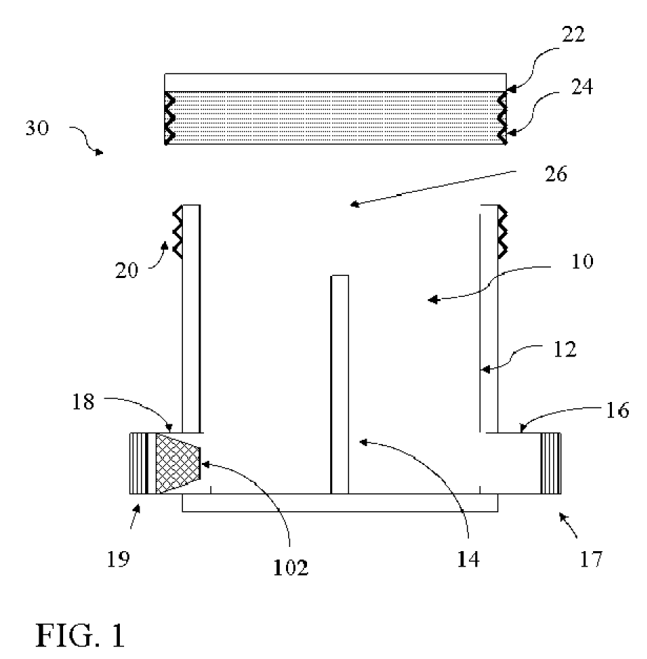

FIG. 1 is a schematic illustration of the fertilizer distribution apparatus invention;

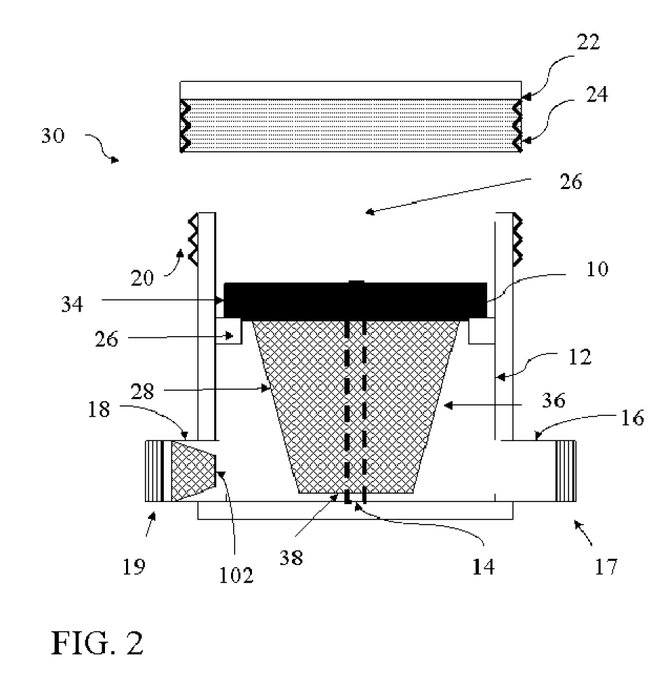

FIG. 2 is a schematic illustration of the fertilizer distribution apparatus invention with integrated fertilizer basket;

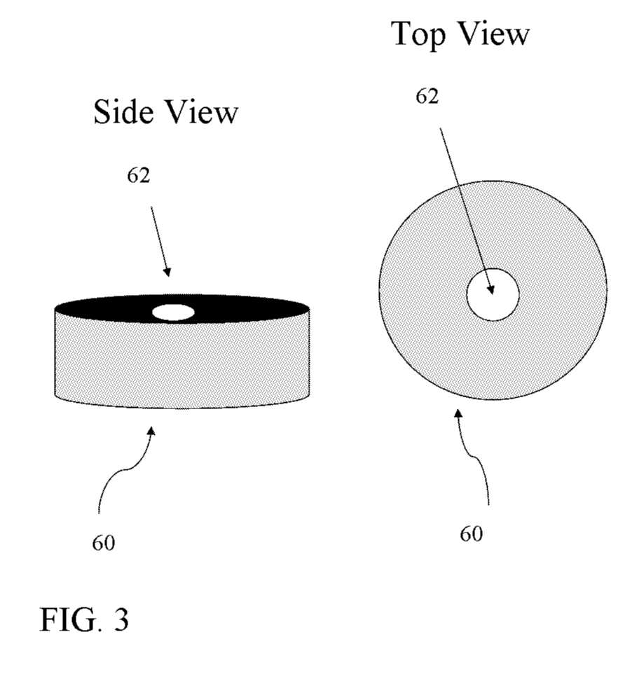

FIG. 3 is a schematic illustration of a fertilizer tablet with integrated cylindrical aperture;

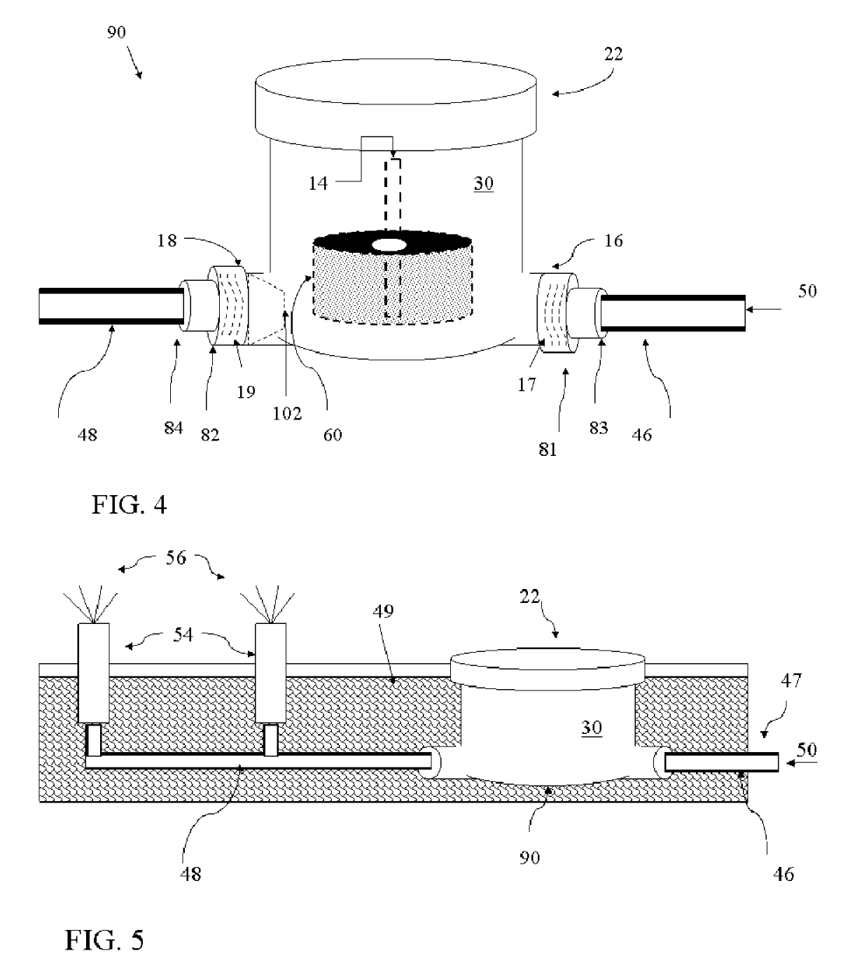

FIG. 4 is a depiction of the fertilizer distribution apparatus invention with fertilizer tablet inserted into canister and connected to irrigation system;

FIG. 5 is a depiction of a simulated irrigation system with the fertilizer distribution apparatus invention incorporated.

FIG.1 is a schematic illustration of the fertilizer distribution apparatus 30. In this embodiment, the fertilizer distribution apparatus 30 and the cylindrical cavity are formed by plastic molding manufacturing. In another embodiment, not depicted, the fertilizer distribution apparatus 30 could be manufactured using other techniques including, but not limited to, metal assembly. The fertilizer distribution apparatus 30 contains an inner cylindrical plastic cavity 1 0 that holds the fertilizing chemicals inside the cavity that is defined by the inner diameter of the cylindrical cavity wall 12. The cylindrical cavity contains a cylindrical opening 26 at the top of the canister to permit access to the inner cylindrical cavity 10. An integrated rod 14 is positioned at the center of the base of the cylindrical cavity 10 and rises to a height not to break the plane of the opening of the top of the canister 12. The integrated rod 14 may be made out of plastic and formed during the molding of the plastic canister 30. In another embodiment not depicted, the integrated rod 14 is manufactured separately and then inserted into the cylindrical cavity 10 to form the finished cylindrical molded canister 30. In another embodiment not depicted, the integrated rod 14 is manufactured using non-plastic material such as wood or a metallic composition. In this embodiment, not depicted, where a separate manufactured rod is utilized, the means of attachment could be conducted by, but not limited too, fitting the integrated rod 14 to the base of the cylindrical cavity 10 by means of compression fit or threaded to tighten into the cylindrical cavity.

At the base of the cylindrical cavity 10, two apertures exist at opposing ends of the fertilizer distribution apparatus 30. On one side, the fluid inlet cylindrical aperture 16 is integrated into the molded cylindrical plastic cavity 10. The fluid inlet cylindrical aperture feature 16 in this embodiment is formed during the molding of the cylindrical cavity 10. In another embodiment not depicted, the fluid inlet cylindrical aperture feature 16 is manufactured separately and later inserted into an opening of the cylindrical cavity 10 to form a water-tight fit and create the finished fertilizer distribution apparatus 30. The fluid inlet cylindrical aperture 16 is designed to mate with existing standard irrigation piping at the exposed opening. This mating of the fluid inlet cylindrical aperture can be accomplished by means of a threaded end 17. In another embodiment not depicted, the mating occurs between the irrigation piping and the fluid inlet cylindrical aperture feature 16 by means of compression fitting. In another embodiment not depicted, the mating occurs using glue between the irrigation piping and the cylindrical aperture feature 16.

On another side of the cylindrical cavity 10, the fluid outlet cylindrical aperture 18 is integrated into the base of the molded cylindrical plastic cavity 10. The fluid outlet cylindrical aperture feature 18 in this embodiment is formed during the plastic molding of the cylindrical cavity 10. In another embodiment not depicted, the fluid outlet cylindrical aperture feature 18 is manufactured separately and later inserted into an opening of the cylindrical cavity 10 to form a water-tight fit and create the finished fertilizer distribution apparatus 30. An outlet screen filter 102 is incorporated into the fluid outlet cylindrical aperture 18 for the purpose of blocking solid material from exiting the cylindrical cavity 10. The fluid outlet cylindrical aperture 18 is designed to mate with existing standard irrigation piping at the exposed opening. This mating of the fluid inlet cylindrical aperture can be accomplished by means of a threaded end 19. In another embodiment not depicted, the mating occurs between the irrigation piping and the fluid outlet cylindrical aperture feature 18 by means of compression fitting. In another embodiment not depicted, the mating occurs using glue between the irrigation piping and the cylindrical aperture feature 18.

The outer diameter of the cylindrical cavity 10 has integrated threads 20 that are present around the circumference of the cavity opening 26. The integrated threading 20 is used to provide the air-tight locking mechanism for the associated lid 22 that is designed with a compatible threaded mechanism 24. The lid 22 can then be placed over the cavity opening 26 and is designed to mate with the integrated plastic threads 20 and can thus be hand tightened by a user of the fertilizer distribution apparatus 30.

FIG. 2 is a schematic illustration of the fertilizer distribution apparatus 30 with integrated fertilizer basket 28; In this embodiment, the plastic cylindrical cavity 10 is formed with an integrated plastic retaining ring 32 that is formed at a depth below the cavity opening 26 along the inner wall of the cylindrical cavity 12. The integrated plastic retaining ring 32 forms a uniform circular planar shelf along the inside cavity diameter 12. The fertilizer basket 28 can now be placed inside the cylindrical cavity 10 such that the fertilizer basket cylindrical edge 34 has an outside diameter that is smaller than the diameter of the cylindrical cavity 10 inner diameter and has an outside diameter larger than the distance between the integrated plastic retaining ring 32 inner diameter. The fertilizer basket 28 rests on the integrated plastic ring 32 and the fertilizer basket cylindrical edge 34 height is such that once placed in the molded cylindrical plastic cavity 10, the height is below the cavity opening 26. In this embodiment, the fertilizer basket 28 has an integrated plastic basket mesh screen 36 that holds the fertilizer. In another embodiment not depicted, a different type of material is used for the plastic mesh screen including, but not limited too, a metal, that can contain different meshing patterns. In this embodiment, the fertilizer basket 28 has a basket aperture 38 located at the base of the basket to permit the basket to fit into the integrated rod 14. The basket aperture diameter will be equal to or greater in diameter as compared the integrated rod 14 diameter. This feature allows the basket to be supported from the base to help keep the basket in place during fluid flow from the irrigation source.

FIG. 3 is a schematic illustration of a fertilizer tablet 60 with integrated cylindrical aperture 62 that would be compatible with the fertilizer distribution apparatus 30. The fertilizer tablet aperture 62 is such that it is located around the center of the fertilizer tablet 60 and has a diameter equal to or greater than the integrated rod 14 diameter permitting the fertilizer tablet 60 to be placed down the length of the integrated rod 14 through the fertilizer tablet aperture 62. In another embodiment, a fertilizer tablet with or without an aperture, could be placed in the fertilizer basket 28. The fertilizer tablet 60 in this embodiment is comprised off chemicals used to accelerate the growth of plants. In another embodiment, the fertilizer tablet 60 is color coded to correspond to different applications such as, but not limited too; weed killing chemicals, plant growth chemicals, and insect attack prevention chemicals. In another embodiment, the fertilizer tablet 60 is color coded to different seasons of the year such as, but not limited too, spring, summer, fall, and winter.

FIG. 4 is a depiction of the fertilizer distribution apparatus 30 connected to fluid irrigation system 47 to form an integrated fertilizer distribution system 90. In this embodiment, the fertilizer tablet 60 is inserted through the integrated rod 14 and connected to irrigation system 47. In this embodiment, to complete the connection of the fertilizer distribution apparatus 30 to the fluid irrigation system 47, two identical threaded connectors 81, 82 are used. The threaded connectors 81, 82 are standard threaded connectors that are compatible with the threaded aperture 17,19 of the permitting a threaded seal fit with proper tightening. The aperture of the threaded connectors 83, 84 is a standard locking design permitting the user to create a compression fit by inserting inlet fluid irrigation piping 46 into the threaded connector aperture 83 and forming a water tight seal. The outlet fluid irrigation piping 48 is then inserted into the threaded connector aperture 84 and forming a water tight seal. In another embodiment not depicted, the threaded connector 81,82 has an integrated filter contained inside the housing. In another embodiment not depicted, the connection of the fluid irrigation piping to the fertilizer distribution apparatus is completed by direct insertion of piping into the fertilizer apparatus apertures forming a compression water tight fit.

FIG. 5 is a depiction of a simulated irrigation system 47 with the fertilizer distribution apparatus 30 incorporated to create the fertilizer distribution system 90. In this embodiment, the fertilizer distribution apparatus 30 is buried in the ground 49 such that access is permitted to the lid 22 to allow the user to replace the fertilizer used for this particular fluid irrigation system 47. The irrigation system fluid flows from inlet point 50 through the fertilizer distribution apparatus 30 dissolving the fertilizer chemical into the irrigation fluid and continues through the outlet fluid irrigation piping 48. In this embodiment, the outlet fluid irrigation piping 48 is connected to sprinklers 54 used to distribute the irrigation fluid 50 that has flowed through the fertilizer distribution apparatus 30. In another embodiment, the outlet fluid irrigation piping is connected to a dripper system. In another embodiment not depicted, the outlet fluid irrigation system is used in conjunction with various distribution devices including, but not limited too, sprinklers and drippers.

It is emphasized that the Abstract is provided to comply with regulations requiring an Abstract that will allow the reader to quickly ascertain the nature and gist of the technical disclosure. It is submitted with the understanding that it will not be used to interpret or limit the scope or meaning of the claims.

In the foregoing Description, various features are grouped together in a single embodiment for the purpose of streamlining the disclosure. This method of disclosure is not to be interpreted as reflecting an intention that the claimed embodiments of the invention require more features that are expressly recited in each claim. Rather, as the following claims reflect, inventive subject matter lies in less than all features of a single disclosed embodiment. Thus the following claims are hereby incorporated into the Description, with each claim standing on its own as a separate preferred embodiment.

It will be readily understood to those skilled in the art that various other changes in the details, material, and arrangements of the parts and method stages which have been described and illustrated in order to explain the nature of this subject matter may be made without departing from the principles and scope of the subject matter as expressed in the subjoined claims.

What is claimed is:

1. A fertilizer distribution apparatus comprising:
A cylindrical canister assembly including:
a cylindrical cavity inside the cylindrical canister to hold liquid or solid chemical material, a cylindrical input aperture that permits fluid flow access from the outside of the canister assembly into the cylindrical cavity with standard pipe connector features;
a cylindrical output aperture that permits fluid flow departure from the inside of the cylindrical plastic cavity to the outside of the cylindrical cavity utilizing standard pipe connector features;
a removable lid used to seal the cylindrical canister and provide an air-tight seal and permit access to the canister.

2. The fertilizer distribution apparatus of claim 1, further comprising:
a raised cylindrical rod rising from the center of the canister base such that the rod is at a height below the opening of the canister.

3. The fertilizer distribution apparatus of claim 2, in which the raised cylindrical rod is formed at the same time as the canister cavity using molded plastic material.

4. The fertilizer distribution apparatus as in any of the preceding claims, in which the fluid outlet cylindrical aperture contains an integrated screen filter.

5. The fertilizer distribution apparatus as in any of the preceding claims, in which
The cylindrical cavity is formed with an integrated plastic retaining ring at a depth below the opening such that the ring forms a uniform circular planar shelf along the inside diameter of the cylindrical cavity.

6. The fertilizer distribution apparatus of claim 5, further comprising:
A removable fertilizer meshed basket with a diameter that is less than the diameter of the cylindrical cavity and has a diameter larger than the integrated plastic retaining ring to permit the suspension of the basket inside the fertilizer distribution apparatus. The depth of the basket is less than the distance between the plastic retaining ring and the bottom of the cylindrical cavity.

7. The fertilizer distribution apparatus of claim 6, further comprising:
The removable fertilizer meshed basket has an aperture at the center of the base of the basket to permit the basket to fit through an integrated cylindrical rod rising from the base of the canister.

8. The fertilizer distribution apparatus as in any of the preceding claims, further comprising:
A cylindrical fertilizer tablet with a diameter less than the diameter of the cylindrical plastic cavity and with a hollowed cylindrical cavity diameter greater than that of the integrated rod rising from the base of the canister assembly is inserted in the fertilizer distribution apparatus by means of the integrated rod rising from the base of the apparatus.

9. The fertilizer distribution apparatus of claim 5 or 6, further comprising:
Fertilizer tablets that are placed in the fertilizer meshed basket such that the fertilizer tablet diameter is larger than the opening permitted in the meshed basket.

10. A fertilizer tablet comprising:
Fertilizer chemicals formed in a solid cylindrical shape with the center portion removed through entire tablet.
